(19) United States
(12) Patent Application Publication
(10) Pub. No.: US 2018/0066807 A1
(43) Pub. Date: Mar. 8, 2018

(54) LED FLUORESCENT LAMP USING FAR-INFRARED RADIATION WITHOUT HEAT SINK

(71) Applicant: WOOSUNG TECH. CO., LTD., Gyeongsan-si Gyeongsangbuk-do (KR)

(72) Inventor: Jong Koo WOO, Gyeongsan-si Gyeongsangbuk-do (KR)

(21) Appl. No.: 15/531,909

(22) PCT Filed: May 19, 2016
(86) PCT No.: PCT/KR2016/005316

§ 371 Date: May 31, 2017

(30) Foreign Application Priority Data
Jan. 18, 2016 (KR) 10-2016-0006088

(51) Int. Cl. F21K 9/278; F21S 4/28; F21V 19/00

(52) U.S. Cl. CPC F21K 9/278; F21Y 2103/10; F21V 19/003; F21S 4/28

(57) ABSTRACT

The present invention relates to an LED fluorescent lamp using far-infrared radiation without a heat sink. According to the present invention, a circuit is formed by peeling the copper foil layers on both sides of the non-metal double-sided PCB substrate. The area of the copper foil layer area on which LEDs are installed in series is maximized. The circuit components are mounted on the outside of the PCB, and the connection circuit is formed on a portion of the substrate surface in which the LEDs are not mounted. The LED fluorescent Lamp utilizes infrared emissivity to provide excellent heat dissipation even though a heat sink is not attached.

### TECHNICAL FIELD

The present invention relates to an LED fluorescent lamp, and more particularly, to an LED fluorescent lamp using far-infrared radiation without a heat sink, in which an area of surface of a copper layer on which LEDs are mounted is fully enlarged when an LED connection circuit is formed by partially removing a copper layer of a non-metal PCB which is formed on both surfaces of a base made of a synthetic resin material, such that heat is radiated through infrared radiation without any heat sinks, thereby reducing the heat generation rate.

### BACKGROUND ART

In recent years, an LED lighting device which uses an LED device as a light source has been widely used due to its long durability, low power consumption and high brightness.

Various kinds of lighting devices have been replaced with the LED lighting devices, one of which is a rod-shaped fluorescent lamp.

The bar-shaped fluorescent lamp is the most common type of a fluorescent lamp and has been used for a long time because of its low power consumption and low cost of lamps. In general, the specifications of the bar-shaped fluorescent lamps are uniform.

Therefore, a lampshade for installing a bar-shaped fluorescent lamp is also widely spread in the industry.

In recent years, there has been proposed a fluorescent lamp type of an LED lamp which allows the lampshade for a conventional rod-shaped fluorescent lamp to be used as it is.

Such a fluorescent lamp type of an LED lamp is provided with a substrate on which an LED device is mounted in a tube which has a circular section and defines the outer appearance thereof, and a heat sink member made of aluminum for radiating heat is provided on the rear surface of the substrate.

The heat sink members have various complex cross-sectional shapes for the heat radiation effects.

As described above, the LED fluorescent lamp compatible with the conventional fluorescent lamp includes a heat sink member. The reason is that the LED itself has a life span longer than that of the conventional fluorescent lamp, but is vulnerable to heat, shortening the life span due to heat, and causing a trouble.

However, a heat sink member having a complicated structure and particularly, made of aluminum or the like having an excellent heat radiation effect is used to construct the LED fluorescent lamp, thereby raising the price of the LED fluorescent lamp.

To solve such problems, there have been disclosed various techniques.

As one example, there has been disclosed a technique of excluding a general printed circuit board in Korean Registered Patent No. 10-1228436 (Patent document 1) entitled ‘Method of manufacturing heat sink member for fluorescent lamp type LED lighting device, which is provided with copper thin film pattern circuit plate attached thereto’, where a copper thin film substrate on which an LED is to be mounted is directly attached to a bottom surface of a heat sink member formed with a heat dissipating pin.

According to the patent document 1, a separate copper thin film substrate is manufactured and directly fixed to the heat sink member, so that the workability is improved and the manufacturing cost is reduced.

However, the cost reduction corresponds to that of a conventional printed circuit board. Although a cost saving effect is expected when the printed circuit board is made of metal, in the case where the substrate is formed based on a plastic material, the manufacturing cost is not reduced. Thus, this is not different to from that of the related art in terms of using a heat sink member.

In addition, since a conventional manufacturing facility must be excluded and a manufacturing facility of a completely new type must be provided, a great deal of cost is required to construct a base manufacturing facility.

As another technique, there has been disclosed a case in Japanese Patent Publication No. 5573468 (Patent document 2), where a through hole is formed in a double-sided substrate provided on the front and rear surfaces thereof with a metal layer, and is used as a ventilation path for radiating heat.

According to the patent document 2, a light emitting device such as an LED is disposed on one surface of a substrate and a lighting circuit component such as a condenser for emitting light from the light emitting device is mounted on the opposite surface of the substrate. Meanwhile, the heat generated from the light emitting device is transferred to the back surface of the substrate at a position which is away from the lighting circuit component such as a capacitor by forming the through hole adjacent from the light emitting device, so that the light emitting device and the lighting circuit component are protected from heat, thereby increasing the density of the substrate.

In this case, according to the patent document 2, a through hole serving as both electrical conduction and heat transfer and a through hole only for conducting electricity are formed.

In addition, since the through holes for transferring heat must be formed close to each LED, a large number of perforations must be formed on the surface of the substrate.

However, the configuration disclosed in the patent document 2 has the following problems.

For example, when the substrate is formed of a metal PCB, a plurality of punching operations must be performed on the surface of the substrate, so that the punching process is increased, and the peripheral surface at the opposite side to the inserting direction of the punching machine is not smoothly formed. Thus, a work for treating the non-smooth portion is required so that it takes much time and effort to process the substrate.

In addition, since metal such as aluminum itself has high thermal conductivity, the heat transfer effect through the through hole is substantially small.

In addition, when the substrate is made of a resin-based non-metal PCB, the non-metal PCB may be easily deformed by heat or weight, so that it is required to install a support to a lower portion thereof. However, it is substantially difficult to install the support to the lower portion due to the structure in which a plurality of lighting circuit components are provided on the opposite side of the surface on which the LED is formed.

In general, the substrate is slidably inserted into the tube to be assembled. In the process of pushing the substrate, the upper end of the support is interfered with the lighting circuit component, so that it may be impossible to assemble the substrate with the tube or the lighting circuit component may be damaged.

To solve the above problems, there has been disclosed a technique in Korean Registered Patent No. 10-1213076 (Patent document 3) entitled ‘Printed circuit board for effective heat radiation, method of manufacturing the same and LED light emitting device’.

As shown in FIG. 1, the patent document 3 discloses a technique of forming a heat sink layer 4 on a surface opposite to a surface on which an LED 1 is installed and a transfer part 2 for transferring, to the heat sink layer, the heat generated from on the surface on which the LED is mounted through an insulating layer at a middle portion of a PCB.

Differently from the patent document 2, according to the patent document 2, the metal circuit of the surface and the heat sink layer of the rear surface are prevented from being electrically connected to each other, such that the heat is transferred to the heat sink layer through the heat transferring portion of metal, not a through hole.

Differently from the patent document 2, the patent document 3 discloses a structure in which the mounted components are disposed on not the rear surface of the substrate but the surface on which the LED is disposed.

However, when the mounted circuit component is disposed on the same surface as the LED, it is impossible to overcome the problem that the LED is damaged due to the heat generated from the mounted circuit component as well as the heat generated from the LED.

In addition, in the patent documents 1 to 3, a metal such as aluminum, which is mainly used as a layer for radiating heat, has a high thermal conductivity but a low thermal emissivity, so heat radiation is mainly achieved through contact with air through a space on the back surface of the substrate. There is no circulation of external air in the sealed fluorescent tube, and the substantial heat radiation effect is lowered, so that the LED is deteriorated, thereby remarkably reducing the life span.

In sum, in developing an LED fluorescent lamp that can be compatible with the conventional fluorescent lamp case, it is urgent to develop a technology that can solve the heat generation problem while reducing the manufacturing cost.

### DOCUMENT OF RELATED ART

(Patent document 1) KR 10-1228436 (Jan. 25, 2013)

(Patent document 2) JP 5573468 (Aug. 20, 2014)

(Patent document 3) KR 10-1213076 (Dec. 11, 2012)

### DISCLOSURE

### Technical Problem

To solve the problems of the related art, the present invention provides an LED fluorescent lamp using far-infrared radiation without a heat sink, which utilizes the copper plate of a conventional dual-side non-metal PCB as a heat sink without using a separated metal heat sink or a metal PCB such that an LED lamp which emits light on both surfaces, and is light in weight, low in cost, and excellent in heat radiation effect is provided.

In detail, since the copper plate used for the dual-side PCB is not only high in thermal conductivity but also high in infrared radiation rate, so that the heat radiation effect by radiation is enhanced, the present invention is to achieve heat radiation by infrared radiation even in a closed tube.

In addition, in order to maximize the infrared emissivity, the present invention maximizes the remaining area of the copper plate, compared to the conventional dual-side PCB where the remaining area of the copper plate used for the circuit is small, thereby maximizing the infrared radiation of the copper plate to increase the heat radiation effect.

In addition, the area of the series type circuit connecting LEDs is maximized so that heat is radiated from the surface of the substrate on which the LEDs are mounted in the form of infrared radiation and the other circuits are arranged in the longitudinal direction of the substrate on the rear side of the substrate, thereby further increasing the heat radiation effect.

In addition, the present invention provides a compatible LED fluorescent lamp in which a ballast of a conventional fluorescent lamp can be used as it is. In addition, the compatible LED fluorescent lamp is usable for the fluorescent lamps using a magnetic ballast and an electronic ballast, except for an SMPS-type ballast of which the circuit structure is complicated, the life span is short, and the heat generation is severe. In addition, the compatible LED fluorescent lamp can minimize the heat generated by the circuit components by constructing the circuit for controlling current using a capacitor for the magnetic ballast and an inductor for the electronic ballast. In addition, the compatible LED fluorescent lamp is provided to have a long life span by minimizing the heat generation without using a separate heat sink and reducing EMI generation because it functions in combination with the infrared radiation configuration using the copper plate of the double-sided PCB.

In addition, a sage preventing member, which is mounted on the rear surface of a PCB to prevent a substrate from sagging, is installed at an inside while being spaced apart from both ends of the tube and a socket is easily coupled with a bolt by utilizing protrusions around a groove into which the sag preventing member is inserted, so that the sag preventing member may be prevented from being damaged due to the collision with the circuit components mounted on an outer circuit portion at both sides and may be prevented from moving to left or right while being inserted.

### Technical Solution

To achieve the objects, in accordance with an aspect of the present invention, there is provided an LED fluorescent lamp using far-infrared radiation without a heat sink, which includes: a tube (10) formed at both sides of an inner peripheral surface thereof with a guide groove (11) extending in a longitudinal direction, formed at a lower side thereof with a fitting groove (12), and formed on an outer peripheral surface thereof, which is opposite to a position of the fitting groove (12), with a transmittance part (13) which is transparent or translucent; a PCB (20) including a base part (21), a plurality of LEDs (22), an upper copper plate circuit layer (23), an outer circuit part (24), and a lower copper plate circuit layer (25), wherein the base part (21) is formed of a synthetic resin material and has both sides inserted into the guide groove (11) such that the base part (21) is installed in the tube (10), the plurality of LEDs (22) are mounted on one side surface (21a) of the base part (21) facing the transmittance part (13) in a longitudinal direction of the base part (21) while being spaced apart from each other, the upper copper plate circuit layer (23) has blank parts (23a) and copper plate parts (23b), the blank part (23a) is formed by peeling a copper thin film corresponding to a middle portion of each LED (22) in a state that the copper thin film is formed on one side surface (21a) of the base part (21), both sides of the blank part (23a) are connected to terminals of the LEDs (22) adjacent to each other in the longitudinal direction of the base part (21) to form a part of a serial circuit, the copper plate part (23b) is formed between adjacent blank parts (23a), the copper plate part (23b) has a rectangular shape having a major length (c) in a direction orthogonal to a connecting direction of adjacent LEDs (22) and a minor length (b) in the connecting direction of the adjacent LEDs (22), the outer circuit part (24) is formed on both outer sides of the base part (21) for receiving external power to control a current, and connected to the upper copper plate circuit layer (23) to supply the current to the LED (22), the lower copper plate circuit layer (25) has both end portions connected to the outer circuit part (24) in a state that a copper thin film is formed on an opposite surface (21b) of the base part (21) opposite to the one side surface (21a) of the base part (21), and the lower copper circuit layer (25) is formed by partially peeling the copper thin film such that the lower copper circuit layer (25) is electrically connected to the upper copper plate part (23) through a through-hole (25a); a socket (30) fitted with both end portions of the tube (10) and formed on an end thereof with a contact pin (31) having one side electrically connected to an external power source and an opposite side electrically connected to the outer circuit part (24); and a sag preventing member (40) having one end fitted into the fitting groove (12) of the tube (10) and an opposite side for supporting the PCB (20) to prevent the PCB (20) from sagging.

A distance between middle points of the adjacent LEDs (22) is 5 mm to 10 mm, the minor length (b) of the copper plate part (23b) in the connecting direction of the adjacent LEDs (22) is 4 mm to 8 mm, and the major length (c) of the copper plate part (23b) in the direction orthogonal to the connecting direction of the adjacent LEDs (22) is 8 mm to 16 mm.

The tube (10) includes two fitting protrusions (12a) formed on an inner peripheral surface of a lower portion of the tube (10) in parallel with each other to define a fitting groove (12) therebetween, the socket (30) includes a bolt guide groove (32) formed at an outer end of the socket (10) in line with the fitting groove (12) of the tube (10), a bolt coupling hole (33) formed on a front end portion of the bolt guide groove (32) in line with the fitting groove (12), and a protrusion receiving member (34) formed inside the bolt coupling hole (33) to allow the fitting protrusion (12a) to be inserted into the protrusion receiving member (34), both side end portions of the sag preventing member (40) are shorter than a length of the base part (21) and spaced apart from the outer circuit part (24), and a bolt (35) is inserted into the fitting groove (12) between an end portion of the sag preventing member (40) and an end portion of the fitting protrusion (12a) through the bolt coupling hole (33).

The outer circuit part (24) includes a power input circuit to which external power is suppled, a current control circuit for restricting or controlling a supplied current, a capacitor connectable to a magnetic stabilizer and an inductor connectable to an electronic stabilizer.

The outer circuit part (24) includes two first terminals (101) connected to a contact pin (31) of one of two sockets, and two second terminals (102) connected to a contact pin (31) of a remaining socket, in a circuit (100) including the upper copper circuit layer (23), the LED (22), the outer circuit part (24) and the lower copper plate circuit layer (25), a first current limiting circuit (105) including a first capacitor (103) and a first resistor (104), which are connected in parallel to each other, is connected to the two first terminals (101), an output terminal of the first current limiting circuit (105) is connected to a rectifier diode bridge (106) including first to sixth diodes, negative resistance coefficient thermistors (107) are connected to the two second terminals, respectively, a second current limiting circuit (111) including a relay (108), a third capacitor (109) and an inductor (110), which are connected in parallel to each other, is connected to output terminals of the two negative resistance coefficient thermistors (107), an output terminal of the second current limiting circuit (111) is connected to a connecting node (112) between fifth and sixth diodes (106e and 106f) of the rectifier diode bridge (106), an LED circuit (113), in which the LEDs (22) are connected in series to each other, is connected to input and output terminals of the rectifier diode bridge (106), a first electrode insulating circuit (117), in which a triac (116) is connected in parallel between a pair of photo-triacs (114) connected in series to each other and a third resistor (115), is connected between the second current limiting circuit (112) and the rectifier diode bridge (106), a second electrode insulating circuit (121), in which a fourth resistor (120) is connected in serial to a pair of photo-triacs (118) connected in parallel to each other and a seventh diode (119), is connected between input and output terminals of the LED circuit (113), and a surge absorber circuit (124), in which a fifth resistor (123) is connected in series to a fourth capacitor (122), is connected between the input and output terminals of the LED circuit (113).

### Advantageous Effects

According to the present invention, there is provided an LED lamp which emits light on both surfaces, and is light in weight, low in cost and excellent in heat radiation effect by utilizing the copper plate of a conventional dual-side non-metal PCB as a heat sink without using a separated metal heat sink or a metal PCB.

In detail, since the copper plate used for the dual-side PCB is not only high in thermal conductivity but also high in infrared radiation rate, so that the heat radiation effect by radiation is enhanced, the present invention is to achieve heat radiation by infrared radiation even in a closed tube.

In addition, in order to maximize the infrared emissivity, the present invention maximizes the remaining area of the copper plate, compared to the conventional dual-side PCB where the remaining area of the copper plate used for the circuit is small, thereby maximizing the infrared radiation of the copper plate to increase the heat radiation effect.

In addition, the area of the series type circuit connecting LEDs is maximized so that heat is radiated from the surface of the substrate on which the LEDs are mounted in the form of infrared radiation and the other circuits are arranged in the longitudinal direction of the substrate on the rear side of the substrate, thereby further increasing the heat radiation effect.

In addition, the present invention provides a compatible LED fluorescent lamp in which a ballast of a conventional fluorescent lamp can be used as it is. In addition, the compatible LED fluorescent lamp is usable for the fluorescent lamps using a magnetic ballast and an electronic ballast, except for an SMPS-type ballast of which the circuit structure is complicated, the life span is short, and the heat generation is severe. In addition, the compatible LED fluorescent lamp can minimize the heat generated by the circuit components by constructing the circuit for controlling current using a capacitor for the magnetic ballast and an inductor for the electronic ballast. In addition, the compatible LED fluorescent lamp is provided to have a long life span by minimizing the heat generation without using a separate heat sink and reducing EMI generation because it functions in combination with the infrared radiation configuration using the copper plate of the double-sided PCB.

In addition, a sage preventing member, which is mounted on the rear surface of a PCB to prevent a substrate from sagging, is installed at an inside while being spaced apart from both ends of the tube and a socket is easily coupled with a bolt by utilizing protrusions around a groove into which the sag preventing member is inserted, so that the sag preventing member may be prevented from being damaged due to the collision with the circuit components mounted on an outer circuit portion at both sides and may be prevented from moving to left or right while being inserted.

### DESCRIPTION OF DRAWINGS

FIG. 1 is perspective view illustrating one example of a substrate for an LED lamp according to the related art.

FIG. 2 is an exploded perspective view illustrating an LED fluorescent lamp using far-infrared radiation without a heat sink according to the present invention.

FIG. 3 is a partial cutting exploded perspective view illustrating an assembly state of an LED fluorescent lamp using far-infrared radiation without a heat sink according to the present invention.

FIG. 4 is a view showing a circuit layer formed on a PCB surface according to the present invention.

(A): Plan view

(B): Rear view

(C): Side sectional view

FIG. 5 is a circuit diagram of an LED fluorescent lamp using far-infrared radiation without a heat sink according to the present invention.

FIG. 6 is a view illustrating an example of further forming a conduction preventing groove and an oxide copper layer according to the present invention.

FIG. 7 is a view showing a test report the result of measuring far-infrared emissivity of a PCB specimen according to the present invention.

### DESCRIPTION OF REFERENCE NUMERAL

10: Tube

11: Guide groove

12: Fitting groove

12a: Fitting groove

13: Transmittance part

14: Opaque part

20: PCB

21: Base part

21a: On side surface

21b: Opposite side surface

22: LED

23: Upper copper plate circuit layer

23a: Blank part

23b: Copper plate part

24: Outer circuit part

25: Lower copper plate circuit layer

26: Oxide copper layer

27: Conduction preventing groove

30: Socket

31: Contact pin

32: Bolt guide groove

33: Bolt coupling hole

34: Protrusion receiving member

35: Bolt

40: Sag preventing member

100: Circuit

101: First terminal

102: Second terminal

103: First capacitor

104: First resistor

### BEST MODE

### Mode for Invention

Hereinafter, an LED fluorescent lamp using far-infrared radiation without a heat sink according to the present invention will be described in detail with reference to accompanying drawings.

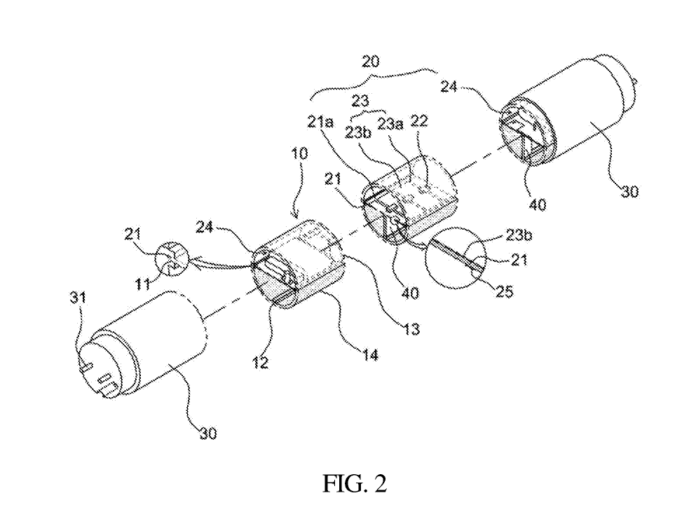

As shown in FIG. 2, an LED fluorescent lamp using far-infrared radiation without a heat sink according to the present invention includes a tube 10, a PCB 20, a socket 30, and a sag preventing member 40.

As shown, the tube 10, which is an element of the present invention, is formed on both inner peripheral surfaces with a guide groove 11 in a longitudinal direction, such that the PCB 20 is slidably inserted and positioned.

A fitting groove 12 is formed on a lower portion of the tube 10.

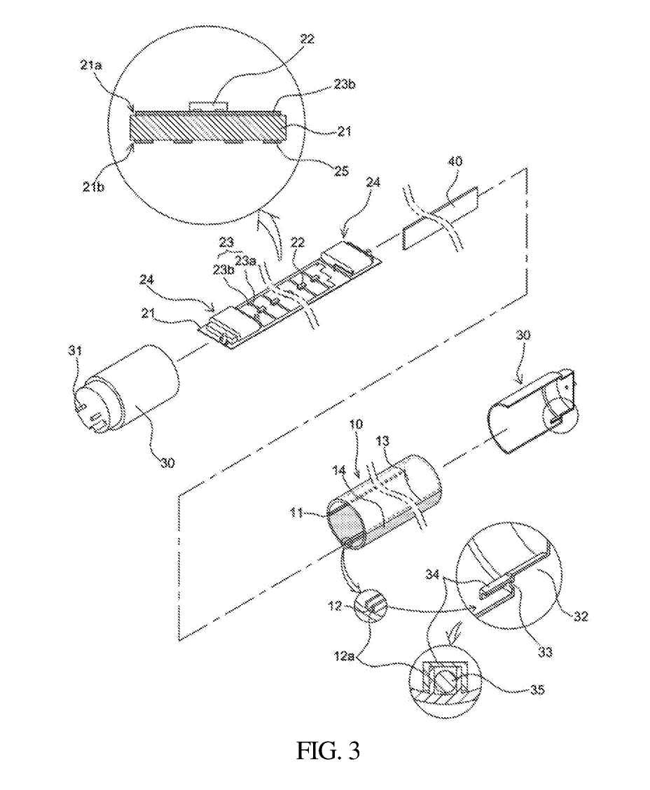

As shown in FIG. 3, preferably, two fitting protrusions 12a protrude inwardly in parallel to each other on the inner peripheral surface of the lower portion of the tube 10 to form the fitting groove 12 between both fitting protrusions 12a.

In addition, the tube 10 may have a transparent or translucent color as a whole, but, as shown, preferably, a transmittance part 13, which is transparent or translucent, is formed on the outer peripheral surface opposite to the position of the fitting groove 12, and an opaque part 14, which is opaque or translucent, is formed on the opposite side to the transmittance part 13 to prevent the mounting components and the like from being viewed from an outside.

The PCB 20 which is an element of the present invention includes a base part 21, an LED 22, an upper copper plate circuit layer 23, an outer circuit part 24, and a lower copper plate circuit layer 25.

The base part 21 which is an element of the PCB 20 is made of an insulating synthetic resin material such as epoxy and as shown in FIGS. 2 and 3, both sides of the base part 21 are fitted into the guide groove 11 such that the base part 21 is installed in the tube 20.

The LED 22 which is an element of the PCB 20 is installed in series on one side surface 21a of the base 21. In detail, plural LEDs 22 are mounted on the surface facing the transmittance part 13 in the longitudinal direction of the base 21 while being spaced apart from each other.

As shown in FIGS. 2 to 4, the upper copper plate circuit layer 23 which is an element of the PCB 20 includes a plurality of blank parts 23a and a copper plate part 23b between the blank parts 23a.

The blank part 23 is formed by peeling a copper thin film corresponding to a middle portion of each LED 22 in a state where the copper thin film is formed on one side surface 21a of the base part 21, such that both sides of the blank part 23 are connected to the LEDs 22 adjacent to each other in the longitudinal direction of the base part 21, thereby forming a part of a serial circuit on an non-metal dual-side PCB of which the surfaces are coated with a copper thin film.

In addition, the copper plate part 23b, which corresponds to a portion where the film is not peeled off relatively, is formed between the adjacent blank parts 23a.

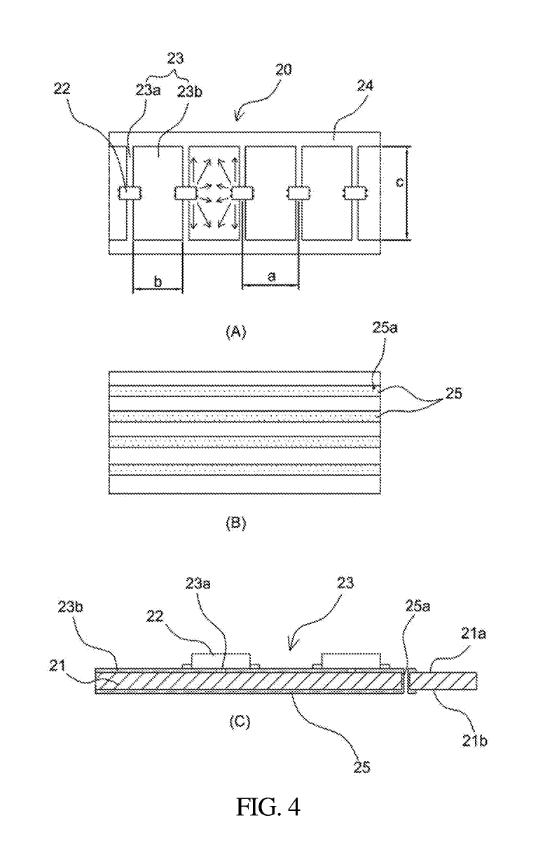

In this case, to solve the problems described above, as shown in FIG. 4, the copper plate part 23b has a rectangular shape having the major length ‘c’ in the direction orthogonal to the connecting direction of the adjacent LEDs 22 and a the minor length ‘b’ in the connecting direction of the adjacent LEDs 22.

As a preferable example, the distance between middle points of the adjacent LEDs 22 is 5 mm to 10 mm, and the length ‘b’ of the copper plate part 23b in the connecting direction of the adjacent LEDs 22 is 4 mm to 8 mm. In addition, the length ‘c’ of the copper plate part 23b in the direction orthogonal to the connecting direction of the adjacent LEDs 22 is 8 mm to 16 mm.

In detail, when the length ‘b’ is 4 mm, the length ‘c’ is 8 mm. When the length ‘b’ is 8 mm, the length ‘c’ is 16 mm. In this manner, the length ‘c’ is always longer than the length ‘b’ . The suitable ratio may be 1:2.

In this case, the difference between the lengths ‘a’ and ‘b’ is maximized while the electrical connection is prevented by setting the length ‘b’ to be smaller than the length ‘a’, so that the entire area of the copper plate part 23b may be maximized.

As shown in FIGS. 2 and 3, the outer circuit part 24 which is an element of the PCB 20 is formed on two outer sides of the base part 21 and receives external power to control current. In addition, the outer circuit part 24 is connected to the upper copper plate circuit layer 23 to supply current to the LED 22.

To this end, the outer circuit part 24 includes a plurality of circuit components including a capacitor, an inductor, a diode and the like which are mounted on one side surface 21a and the opposite side surface of the base part 21.

Like the upper copper plate circuit layer 22, the lower copper plate circuit layer 25, which is an element of the PCB 20, is formed by peeling the copper thin film of one side surface of the non-metal dual-side PCB which is provided while being coated with the copper thin film. In detail, both ends of the lower copper circuit layer 25 electrically connected to the outer circuit part 24 in a state in which the copper film is formed on an opposite side surface to the one side surface 21a of the base part 21, and the copper thin film is partially peeled such that the lower copper plate circuit layer 25 is electrically connected to the upper copper circuit layer 23 through a through-hole 25a.

The upper copper plate circuit layer 22, the lower copper plate circuit layer 25 and a circuit part of the outer circuit part 24 may be formed by removing the copper thin films on both surfaces of a non-metal dual-side PCB, which is purchased inexpensively in the market, through schemes such as etching, corroding, peeling and the like. After the circuit is formed through the peeling of the copper thin film, the PCB 20 may be manufactured by mounting the LEDs 23 and the circuit components. In addition, the PCB 20 may be coated with insulating paint before mounting the LEDs 23 and the circuit components.

The socket 30, which is an element of the present invention, is fitted with two end portions of the tube 10, where one side of the socket 30 is electrically connected to an external power source, and a contact pin 31 electrically connected to the outer circuit part 24 is formed on an end of the socket 30.

As one preferable example of the socket 30, as shown in FIG. 3, the socket 30 includes a bolt guide groove 32 formed on an outer end of the socket 10 to be in line with the fitting groove 12 of the tube 10, and a bolt coupling hole 33 formed on a front end portion of the bolt guide groove 32 to be in line with the fitting groove 12.

In this case, a protrusion receiving member 34 may be formed inside the bolt coupling hole 33 to allow the fitting protrusion 12a to be inserted to an inside of the fitting protrusion 12a.

In this case, preferably, two side end portions of the sag preventing member 40 are shorter than a length of the base part 21 while being spaced apart from the outer circuit part 24.

In the above-described configuration, as shown, a bolt 35 may be fitted into the fitting groove 12 by inserting the bolt 35 into the fitting groove 12 between an end portion of the sag preventing member (40) and an end portion of the fitting protrusion 12a through the bolt coupling hole 33.

In the configuration, the outer circuit part 24 described above is formed on one side surface 21a and the opposite side surface 21b of both side ends of the base part 21, and the sag prevention member 40 is formed to be shorter than the length of the base part 21 such that the components of the outer circuit part 24 are prevented from being damaged. In addition, the fitting groove 12 relatively generating a free space may be utilized to couple the tube 10 and the socket 30 to each other.

In this case, the protrusion receiving member 34 guides the coupling of the tube 10 and the socket 30 before being coupled with the bolt 35, thereby allowing the bolt 35 to be precisely inserted into the fitting groove 12 in assembly.

In addition, if possible, the length of the bolt 35 is set to be in contact with the end of the sag preventing member 40 in the state in which the installation is completed, so that the sag preventing member 40 moves to left or right in the state in which the sag preventing member 40 is inserted into the fitting groove 12, thereby preventing the mounted circuit components from being damaged.

One side end of the sag preventing member 40, which is an element of the present invention, is fitted to the fitting groove 12 of the tube 10, and the opposite end thereof supports the PCB 20 so that the PCB 20 is prevented from sagging. The sag preventing member 40 may be formed of metal such as aluminum or rigid plastic such as epoxy, bakelite, and the like.

In the above-described configuration, the heat generated from the LED 22 placed at both sides in the middle area is transferred to the copper plate part 23b of the upper copper plate circuit layer 23, so that the heat may be concentrated in the middle area than other areas.

Of course, although the heat is transferred to an outside, this area is relatively closer to the LED 22 than other areas, so when the initial high temperature heat is conducted and concentrated compared to other areas, the possibility of overheating the LED 22 should be taken into consideration.

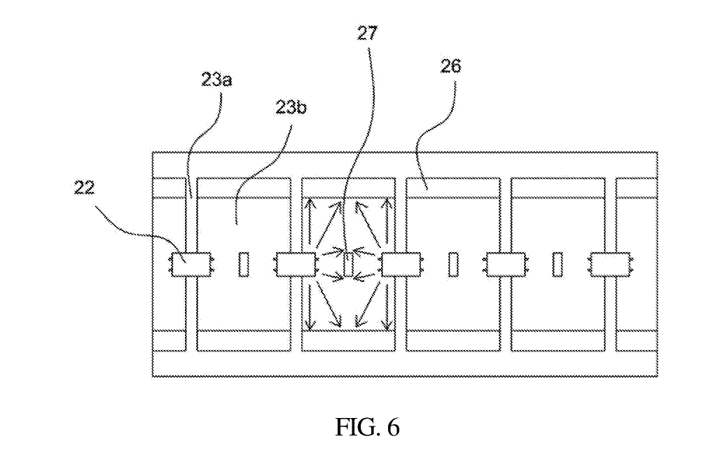

In order to prevent such a phenomenon, as shown in FIG. 6, the copper plate part 23b may allow a conduction preventing groove which is blocked by the base part 21 to be formed between the adjacent LEDs 22 to guide the conduction direction of the heat generated from the LEDs 22 to the outer layer of the copper plate portion 23b at the maximum.

In addition, as shown in FIG. 6, the copper plate portion 23b may allow a copper oxide layer 26 to be formed, where both longitudinal ends of the copper oxide layer 26 are oxidized.

It has been known that the in infrared emissivity of the copper oxide is at least 5 to 10 times higher than that of copper.

Therefore, infrared radiation may be actively performed using the copper oxide layer 26.

Specifically, the copper oxide layer 26 may be formed by exposing the outer periphery of the copper plate part 23b to air, by heat-treating the outer periphery of the copper plate part 23b, or by oxidizing the outer periphery of the copper plate part 23b using a compound or the like, without separately coating or plating the copper plate part 23b. Thus, this part may also enhance the heat radiation effect without any difficult processes.

Of course, after the copper oxide layer 26 is formed, all the one surface 21a and the opposite surface 21b of the base part 21 are coated with an insulating paint or the like as described above.

Alternatively, it may be formed by intentionally exposing the end side of the copper plate part 23b to be oxidized, a specific extent in the course of coating the insulating film to oxidize it by air, and then coating the entirety again while the insulating thin film is coated.

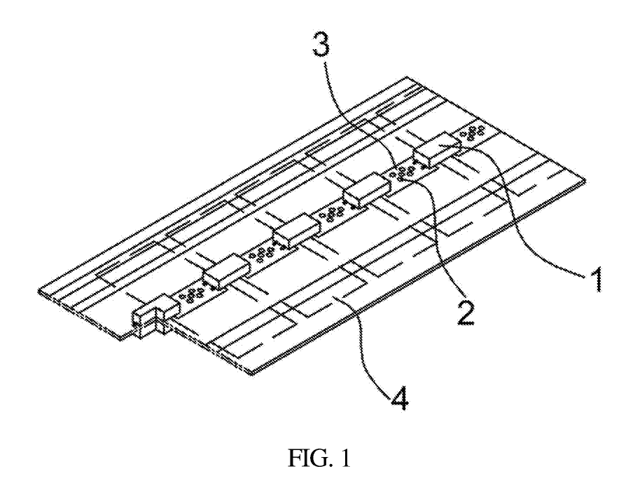

The above-described configuration is greatly different from that of the conventional copper thin film circuit layer of the PCB for an LED of FIG. 1 proposed as a reference.

In the conventional copper thin film circuit layer, the length of the portion corresponding to the symbol ‘a’ is shorter than that of the portion corresponding to the symbol ‘c’ in FIG. 4. This is for the purpose of leaving only a minimum area for electrically connecting the LEDs.

In addition, differently from the related art of FIG. 1, the middle portion of the one side surface 21a of the base part 21 is formed with only the LEDs 22 and the copper plate part 23b for connecting the LEDs 22 in series, and the copper thin film for forming the other circuits is formed on the opposite side surface 21b of the base part 21 and the outer area of the base 21 so that the area of the copper plate part 23b are maximized. In this case, as compared with the related art, the length ‘c’ in the direction orthogonal to the connecting direction of adjacent LEDs 22 is longer than the length ‘b’ in the connecting direction of the adjacent LEDs 22.

Due to such a structure, the heat generated from the LED is transferred to the surface of the copper plate part 23b, which is remarkably enlarged in area, and is radiated in the form of infrared radiation in this state.

That is, the heat is radiated in the form of infrared radiation through the surface of the substrate on which the LED 22 is disposed.

As described above, since the heat is radiated in the form of infrared radiation, the heat radiation effect may be obtained without external air, so that the expensive heat sink such as expensive metal PCB or aluminum may not be required or the demand quantity thereof may be minimized. Therefore, it is possible to provide an LED fluorescent lamp having a low manufacturing cost, a long life span, and a light weight.

Specifically, the configuration for heat radiation is formed by a process of removing a copper thin film such as etching for forming a copper thin film circuit layer, which is a necessary process of a dual-side non-metal PCB. Thus, the process for heat radiation may be eliminated or greatly minimized, and the amount of removed copper thin film is minimized, so that the process required for reprocessing the removed copper thin film is drastically reduced, so the benefit thereof may be very large.

Meanwhile, in order to maximize the heat radiation effect of the infrared radiation scheme by maximizing the surface area of the copper plate part 23b, since the heat generated from the power source part for a conventional LED lamp is large, it is also important to minimize the heat generated from the power source part.

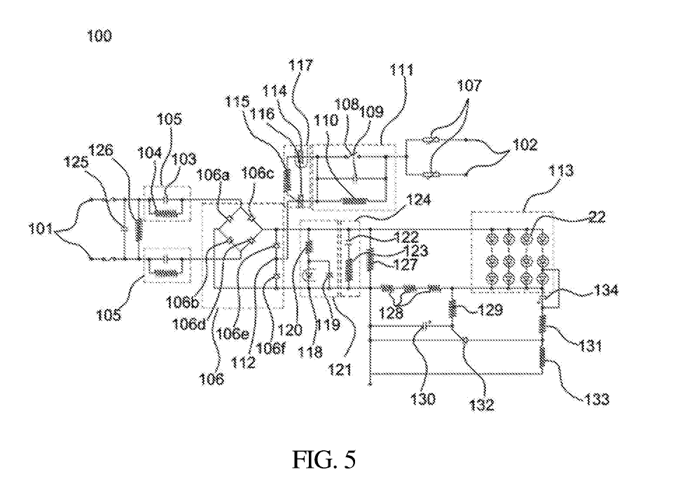

The configuration of a preferable circuit for this end is shown in FIG. 5.

First, the outer circuit part 24 described above includes two first terminals 101 connected to a socket contact pin 31 of one of two sockets, and two second terminals 102 connected to a contact pin 31 of the remaining socket 30. The entire circuit 100 includes the upper copper plate circuit layer 23, the LED 22, the outer circuit part 24, and the lower copper plate circuit layer 25.

In addition, as shown, a first current limiting circuit 105 includes a first capacitor 103 and a first resistor 104 connected in parallel to the two first terminals 101, and an output terminal of the first current limiting circuit (105) is connected to a rectifier diode bridge (106) including first to sixth diodes.

Negative resistance coefficient thermistors 107 are connected to the two second terminals, respectively.

A second current limiting circuit 111, in which a relay 108, a third capacitor 109 and an inductor 110 are connected in parallel to each other, is connected to output terminals of the two negative resistance coefficient thermistors 107.

The output terminal of the second current limiting circuit 111 is connected to a connecting node 112 between fifth and sixth diodes (106e and 106f) of the rectifier diode bridge 106.

An LED circuit 113, in which the LEDs 22 are connected in series to each other, is connected to the input and output terminals of the rectifier diode bridge 106.

A first electrode insulating circuit 117, in which a triac 116 is connected in parallel between a pair of phototriacs 114 connected in series to each other and a third resistor 115, is connected between the second current limiting circuit 112 and the rectifier diode bridge 106.

A second electrode insulating circuit 121, in which a fourth resistor 120 is connected in serial to a pair of phototriacs 118 connected in parallel to each other and a seventh diode 119, is connected between the input and output terminals of the LED circuit 113.

A surge absorber circuit 124, in which a fifth resistor 123 is connected in series to a fourth capacitor 122, is connected between the input and output terminals of the LED circuit 113.

In addition, a fifth capacitor 125 and a sixth resistor 126 are connected in parallel between the two first current limiting circuits 105 and the first terminal 101.

A seventh resistor 127 is connected between the input and output terminals of the LED circuit 113.

A plurality of eighth resistors 128 are connected in series between the output terminal of the LED circuit 113 and the surge absorber circuit 124.

A ninth resistor 129 and a sixth capacitor 130 which are connected in series to each other are connected in parallel to the eighth resistor 128 and the output terminal of the LED circuit 113.

A tenth resistor 131 and an SCR 132 which are connected in series to each other are connected in parallel to the output terminal of the LED circuit 113 and the eighth resistor 128, where the SCR 132 is connected to a contact node between the ninth resistor 129 and the sixth capacitor 130.

A first relay 133 is connected in parallel between the output terminal of the tenth resistor 131 and the output terminal of the eighth resistor 128.

Reference numeral 134, which is not described above, represents a seventh capacitor connected in series between the output terminal of the LED circuit 113 and the input terminal of the tenth resistor 131.

The circuit configuration may use the existing fluorescent lamp ballast as it is in such a manner that the lamp is replaced with the LED, and is compatible with the fluorescent lamp using a magnetic type ballast (in a scheme using a start lamp) or an electronic type ballast.

Generally, the LED fluorescent lamp adapts a scheme of using an SMPS. However, since the fluorescent lamp using this scheme has a complicated circuit, a short life span, and a lot of heat and involves EMI, when the SMPS scheme is applied to the LED fluorescent lamp of the present invention, the heat radiation effect using the infrared radiation through the copper plate part 23b may be reduced.

On the other hand, the circuit 100 having the above-described configuration solves the problems described above and includes the circuit composed of a capacitor and an inductor, so that the circuit is simple and generates little heat. Thus, the circuit 100 has a long life span and does not generate EMI.

Describing the operation of the circuit 100 described above, electric power is selectively supplied to the first terminal 101 and the second terminal 102 from an existing fluorescent ballast.

Since it is impossible to know which of the first terminal 101 and the second terminal 102 is to be supplied with power according to the internal connection of the fluorescent lamp, the same circuits are constructed in duplicate. First, the current supplied to the both terminals is converted into a direct current through the rectifier diode bridge 106 composed of the first to sixth diodes and is supplied to the LEDs 22.

In this case, the voltage is automatically determined according to the number of the LEDs 22.

The current limiting circuit including the first current limiting circuit 105 and the second current limiting circuit 112 limits or adjusts the applied current.

In this case, when the magnetic ballast to which the alternating current of 60 Hz which is the commercial power source is inputted is connected to an outside, the first capacitor 103 of the first current limiting circuit 105 performs the current limiting function. When the magnetic ballast using the alternating current of 20 KHz to 45 KHz is connected to an outside, the inductor 110 of the second current limiting circuit 112 performs the current limiting function.

If the current does not exceed the specified value, that is, if the voltage of the plurality of eighth resistors 128 connected in series between the output terminal of the LED circuit 113 and the surge absorber circuit 124 is low, so that the SCR 132 cannot be turned on. Thus, the first relay 133 is activated to directly supply the power through the contact node of the first relay 133. To the contrary, when the current exceeds the specified value, the SCR 132 is turned on, so that the first relay 133 is deactivated to allow the current to pass through the inductor 110, thereby limiting the current.

Meanwhile, when one end of the bulb is inserted into the socket, current may flow through the other electrode because of the characteristics of the compatible LED lamp, so that there is a risk of electric shock. Thus, the electrode insulation circuit is required to insulate both the left and right electrodes before the bulb is completely inserted into both sockets.

In the circuit 100, even if only the first terminal 101 or the second terminal 102 is inserted into the socket, a current cannot flow through the rectifier end of the rectifier diode bridge 106 composed of the first to sixth diodes, so that the phototriacs 114 and 118 cannot turn on. Thus, the triac 116 does not conduct to maintain the insulation.

In this case, when the opponent terminal is inserted into the socket, a current flows through the rectifier end, so that the triac 116 maintains the conduction state. Thus, all circuits operate normally.

When the rapid-start type fluorescent lamp ballast is powered on, the filament heating current is supplied for a few seconds at the beginning stage of the current supply. When the second terminal 102 is immediately connected, a short-circuit state is established. However, since the negative resistance coefficient thermistor 107 is installed, the resistance is increased, thereby restricting the current. Once the current begins to flow, the temperature rises within a few seconds to reduce the resistance, so that there is no effect on the entire circuit thereafter.

The circuit 100 described above may be applied to a conventional fluorescent lamp socket equipped with a magnetic type ballast or an electronic type ballast without a conventional SMPS while minimizing the amount of heat generated by using a capacitor and an inductor.

Meanwhile, the inventor of the present application prepared a specimen which has a width of 21 mm and a length of 30 mm by cutting the PCB 20 which has a width of 21 mm and a length of 1,187 mm and on which 96 LEDs 22 are mounted.

The area of the copper plate part 23b in the prepared specimen was made to be 95% of the total area.

Then, the prepared specimen was submitted to the Korea Far Infrared Application Evaluation Institute for the infrared emissivity test thereof.

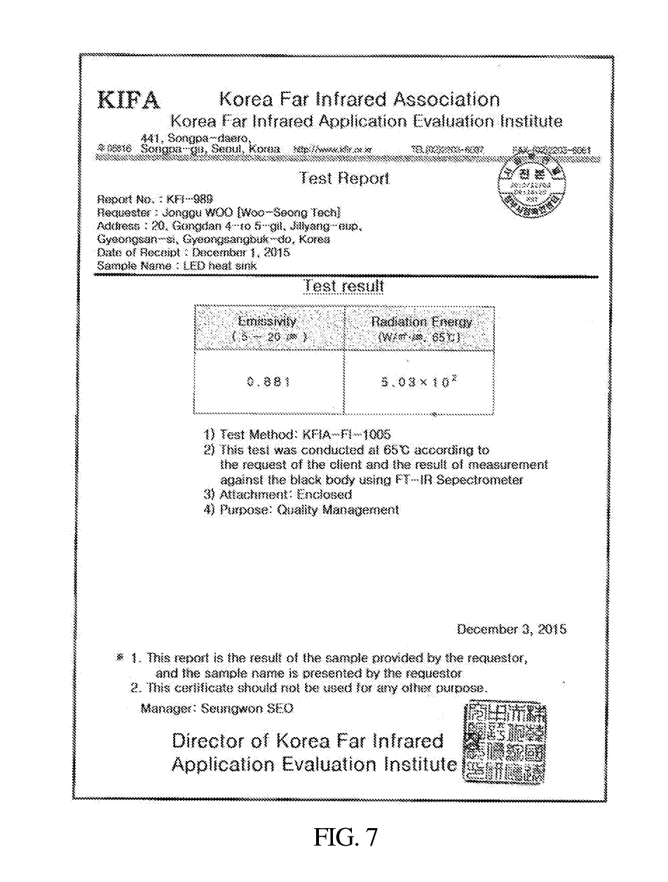

The test was carried out in the method of KFIA-FI-1005. As a result of the test, the radiant energy of 5.03×10² W/m² μm, 65° C. (emissivity of 0.881,5 to 20 μm) was measured as shown in FIG. 7.

The heat radiation capability that can sufficiently radiate heat generated from the LED fluorescent lamp driven at an input power of 20 W to 30 W by about 11.6 W when the heat radiation area is 21 mm×1,100 mm at an ordinary operating temperature of the LED fluorescent lamp was confirmed from the test result.

That is, the LED fluorescent lamp of the present invention can obtain a sufficient heat radiation effect even without a separate metal heat sink. In addition, since he LED fluorescent lamp emits heat energy in the form of far-infrared radiation, the he LED fluorescent lamp may be advantageous to skin health as compared with existing fluorescent lamps emitting harmful ultraviolet rays, and also may reduce cooling load as compared to existing LED fluorescent lamps that transfer heat through contact with air.

### INDUSTRIAL APPLICABILITY

The LED fluorescent lamp of the present invention may be used as a lighting device for various buildings such as a house, a building, a factory, etc., and is compatible with a conventional fluorescent lamp with a ballast.

1. An LED fluorescent lamp using far-infrared radiation without a heat sink, the LED fluorescent lamp comprising:
a tube (10) formed at both sides of an inner peripheral surface thereof with a guide groove (11) extending in a longitudinal direction, formed at a lower side thereof with a fitting groove (12), and formed on an outer peripheral surface thereof, which is opposite to a position of the fitting groove (12), with a transmittance part (13) which is transparent or translucent;
a PCB (20) including a base part (21), a plurality of LEDs (22), an upper copper plate circuit layer (23), an outer circuit part (24), and a lower copper plate circuit layer (25), wherein the base part (21) is formed of a synthetic resin material and has both sides inserted into the guide groove (11) such that the base part (21) is installed in the tube (10), the plurality of LEDs (22) are mounted on one side surface (21a) of the base part (21) facing the transmittance part (13) in a longitudinal direction of the base part (21) while being spaced apart from each other, the upper copper plate circuit layer (23) has blank parts (23a) and copper plate parts (23b), the blank part (23a) is formed by peeling a copper thin film corresponding to a middle portion of each LED (22) in a state that the copper thin film is formed on one side surface (21a) of the base part (21), both sides of the blank part (23a) are connected to terminals of the LEDs (22) adjacent to each other in the longitudinal direction of the base part (21) to form a part of a serial circuit, the copper plate part (23b) is formed between adjacent blank parts (23a), the copper plate part (23b) has a rectangular shape having a major length (c) in a direction orthogonal to a connecting direction of adjacent LEDs (22) and a minor length (b) in the connecting direction of the adjacent LEDs (22), the outer circuit part (24) is formed on both outer sides of the base part (21) for receiving external power to control a current, and connected to the upper copper plate circuit layer (23) to supply the current to the LED (22), the lower copper plate circuit layer (25) has both end portions connected to the outer circuit part (24) in a state that a copper thin film is formed on an opposite surface (21b) of the base part (21) opposite to the one side surface (21a) of the base part (21), and the lower copper circuit layer (25) is formed by partially peeling the copper thin film such that the lower copper circuit layer (25) is electrically connected to the upper copper plate part (23) through a through-hole (25a);
a socket (30) fitted with both end portions of the tube (10) and formed on an end thereof with a contact pin (31) having one side electrically connected to an external power source and an opposite side electrically connected to the outer circuit part (24); and
a sag preventing member (40) having one end fitted into the fitting groove (12) of the tube (10) and an opposite side for supporting the PCB (20) to prevent the PCB (20) from sagging.

2. The LED fluorescent lamp of claim 1, wherein a distance between middle points of the adjacent LEDs (22) is 5 mm to 10 mm,
the minor length (b) of the copper plate part (23b) in the connecting direction of the adjacent LEDs (22) is 4 mm to 8 mm, and
the major length (c) of the copper plate part (23b) in the direction orthogonal to the connecting direction of the adjacent LEDs (22) is 8 mm to 16 mm.

3. The LED fluorescent lamp of claim 2, wherein the tube (10) includes two fitting protrusions (12a) formed on an inner peripheral surface of a lower portion of the tube (10) in parallel with each other to define a fitting groove (12) therebetween,
the socket (30) includes a bolt guide groove (32) formed at an outer end of the socket (10) in line with the fitting groove (12) of the tube (10), a bolt coupling hole (33) formed on a front end portion of the bolt guide groove (32) in line with the fitting groove (12), and a protrusion receiving member (34) formed inside the bolt coupling hole (33) to allow the fitting protrusion (12a) to be inserted into the protrusion receiving member (34),
both side end portions of the sag preventing member (40) are shorter than a length of the base part (21) and spaced apart from the outer circuit part (24), and
a bolt (35) is inserted into the fitting groove (12) between an end portion of the sag preventing member (40) and an end portion of the fitting protrusion (12a) through the bolt coupling hole (33).

4. The LED fluorescent lamp of claim 2, wherein the outer circuit part (24) includes a power input circuit to which external power is suppled, a current control circuit for restricting or controlling a supplied current, a capacitor connectable to a magnetic stabilizer and an inductor connectable to an electronic stabilizer.

5. The LED fluorescent lamp of claim 3, wherein the outer circuit part (24) includes two first terminals (101) connected to a contact pin (31) of one of two sockets, and two second terminals (102) connected to a contact pin (31) of a remaining socket,
in a circuit (100) including the upper copper circuit layer (23), the LED (22), the outer circuit part (24) and the lower copper plate circuit layer (25),
a first current limiting circuit (105) including a first capacitor (103) and a first resistor (104), which are connected in parallel to each other, is connected to the two first terminals (101),
an output terminal of the first current limiting circuit (105) is connected to a rectifier diode bridge (106) including first to sixth diodes,
negative resistance coefficient thermistors (107) are connected to the two second terminals, respectively,
a second current limiting circuit (111) including a relay (108), a third capacitor (109) and an inductor (110), which are connected in parallel to each other, is connected to output terminals of the two negative resistance coefficient thermistors (107),
an output terminal of the second current limiting circuit (111) is connected to a connecting node (112) between fifth and sixth diodes (106e and 106f) of the rectifier diode bridge (106),
an LED circuit (113), in which the LEDs (22) are connected in series to each other, is connected to input and output terminals of the rectifier diode bridge (106),
a first electrode insulating circuit (117), in which a triac (116) is connected in parallel between a pair of photo-triacs (114) connected in series to each other and a third resistor (115), is connected between the second current limiting circuit (112) and the rectifier diode bridge (106),
a second electrode insulating circuit (121), in which a fourth resistor (120) is connected in serial to a pair of photo-triacs (118) connected in parallel to each other and a seventh diode (119), is connected between input and output terminals of the LED circuit (113), and
a surge absorber circuit (124), in which a fifth resistor (123) is connected in series to a fourth capacitor (122), is connected between the input and output terminals of the LED circuit (113).
